(19) United States
(12) Patent Application Publication
(10) Pub. No.: US 2013/0330964 A1
(43) Pub. Date: Dec. 12, 2013

(54) CONNECTOR CABLE STOWAGE SYSTEM FOR HANDHELD AND MOBILE COMPUTING DEVICE ACCESSORIES

(71) Applicants: Paul C. Williamson, Providence, RI (US); Jae Jun Park, Lincoln, RI (US); John E. O'Donnell, Ft. Lauderdale, FL (US)

(72) Inventors: Paul C. Williamson, Providence, RI (US); Jae Jun Park, Lincoln, RI (US); John E. O'Donnell, Ft. Lauderdale, FL (US)

(73) Assignee: AKAI PROFESSIONAL, L.P., Cumberland, RI (US)

(21) Appl. No.: 13/494,335

(22) Filed: Jun. 12, 2012

(51) Int. Cl. H01R 11/11

(52) U.S. Cl. 439/502

(57) ABSTRACT

A connector cable stowage system for an accessory device for a handheld computing device is disclosed. The accessory device has a housing. The stowage system includes a connector cable that has a head with a connector and a cable. The connector is adapted for electrical connection to a handheld computing device. The cable is electrically connected to an accessory device. A head receptacle is molded in the housing of the accessory device. The head receptacle is configured to receive the head of the connector cable therein.

### BACKGROUND OF THE INVENTION

1. Field of the Invention

This patent document relates generally to accessory devices for mobile and handheld computing devices, such as smartphones, tablet computers and related form factors, and more particularly to a method of stowing and device for stowing data connector cables that enable data transfer between the accessory device and the handheld computing device.

2. Background of the Related Art

Tablet computers, smartphones, music players, ereaders and the like (“handheld computing devices”) often have limited input means, such as a touch screen interfaces and a few dedicate buttons. Even if a particular device includes a full keyboard, such keyboards are often cramped with tiny keys.

To provide consumers with a wider range of input means to handheld computing devices, accessory devices for handheld computing device have been created to provide additional functionality in the form of custom controls and interfaces. Input from these dedicated interfaces can be transferred to the handheld computing devices wirelessly, through a fixed dock or a wire.

Often a dedicated connection through a dock or wire is desired to increase security and reliability of the connection and decrease the cost of the accessory device. A fixed dock suffers from the limitation that the orientation of the handheld computing device is not adjustable. Accessory devices that use a wired connection allow the handheld computing device to be easily reoriented, but suffer from the limitation of having a dangling connector

Accordingly, there is a need in the industry for a wired connection for an accessory device for a handheld computing device that permits the handheld computing device to be reoriented and also eliminates the limitation of having a dangling wire.

### SUMMARY OF THE INVENTION

The connector cable stowage system described herein solves the problems of the prior art by providing a connector cable stowage system for an accessory device for a handheld computing device. The accessory device has a housing. A connector cable has a head with a connector and a cable extending from the housing. The connector is further adapted for electrical connection to a handheld computing device. The cable electrically connected to an accessory device. A head receptacle is molded in the housing of the accessory device. The head receptacle is further configured and arranged to receive the head of the connector cable securely therein when not in use.

### BRIEF DESCRIPTION OF THE DRAWINGS

These and other features, aspects, and advantages of the present invention will become better understood with reference to the following description, appended claims, and accompanying drawings where:

FIG. 1 is a perspective view of a first embodiment of an accessory device implementing the connector cable stowage system with the connector cable un-stowed;

FIG. 2 is a perspective view of a first embodiment of an accessory device implementing the connector cable stowage system with the connector cable stowed;

FIG. 3 is a perspective view of a second embodiment of an accessory device implementing the connector cable stowage system with the connector cable un-stowed and connected to a handheld computing device; and

FIG. 4 is a perspective view of a second embodiment of an accessory device implementing the connector cable stowage system with the connector cable stowed.

### DESCRIPTION OF THE PREFERRED EMBODIMENT

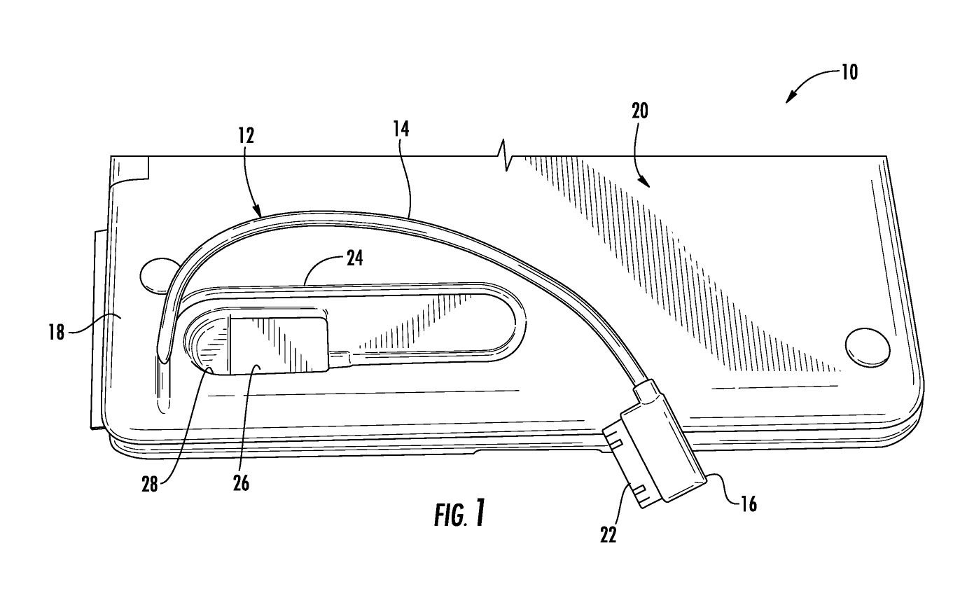

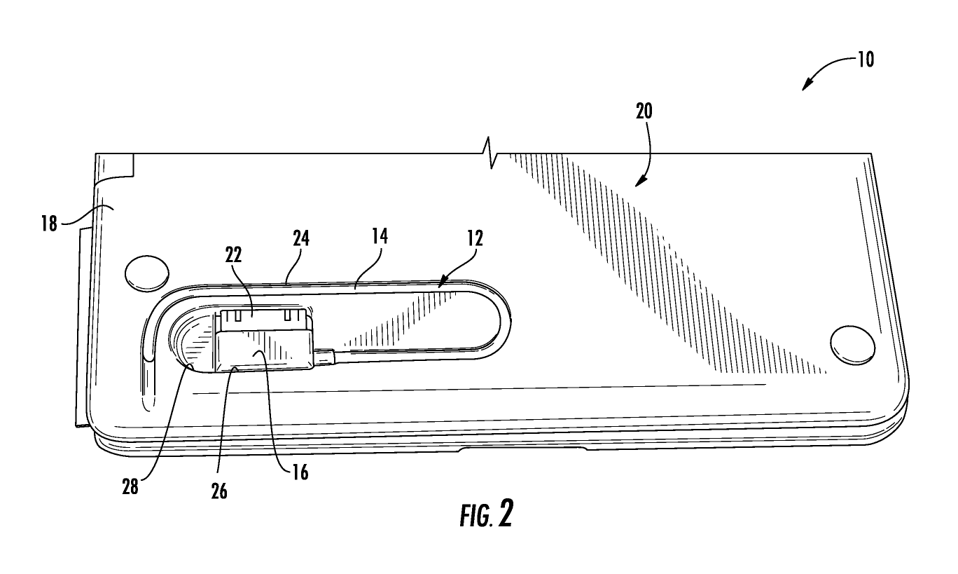

Referring to FIGS. 1 and 2, a first embodiment of an accessory device implementing the connector cable stowage system is shown generally at 10. The connector cable stowage system 10 includes a connector cable 12 having a cable 14 that terminates with a head 16. The cable 14 is connected to the electronics (not shown) contained inside a housing 18 of the accessory device 20.

The head 16 includes a connector 22 adapted to insert into a data port on a handheld computing device. Control signals from the accessory device 20 are transmitted through the connector cable 14 to the handheld computing device as is known in the art.

A housing 18 of the accessory device 20 includes a cable guide 24 molded therein. The cable guide 24 is sized and dimensioned to receive the cable 14 frictionally fit, press-fit or snap-fit into the cable guide 24. The cable guide 24 may be arranged in a spiral-like pattern, which allows the cable guide 24 to be fit onto a smaller area on the housing 18; however, the cable guide 24 may be straight or include other twists and turns as desired.

A head receptacle 26 molded in the housing 18 of the accessory device 20 at the end of the cable guide 24. The head receptacle 26 is sized to receive the head 16 and connector 22 of the connector cable 12 therein. The head receptacle 26 receives the head 16 of the connector cable 12 with a frictional fit, snap-fit or press-fit arrangement. The head 16 rests flush with the outer surface of the housing 18 when lodged in the head receptacle 26. The head receptacle 26 further includes a relief 28 forming recess adjacent to the head 16 when the head 16 is placed in the head receptacle 26, which permits the user to pry it from the housing 18 with a finger.

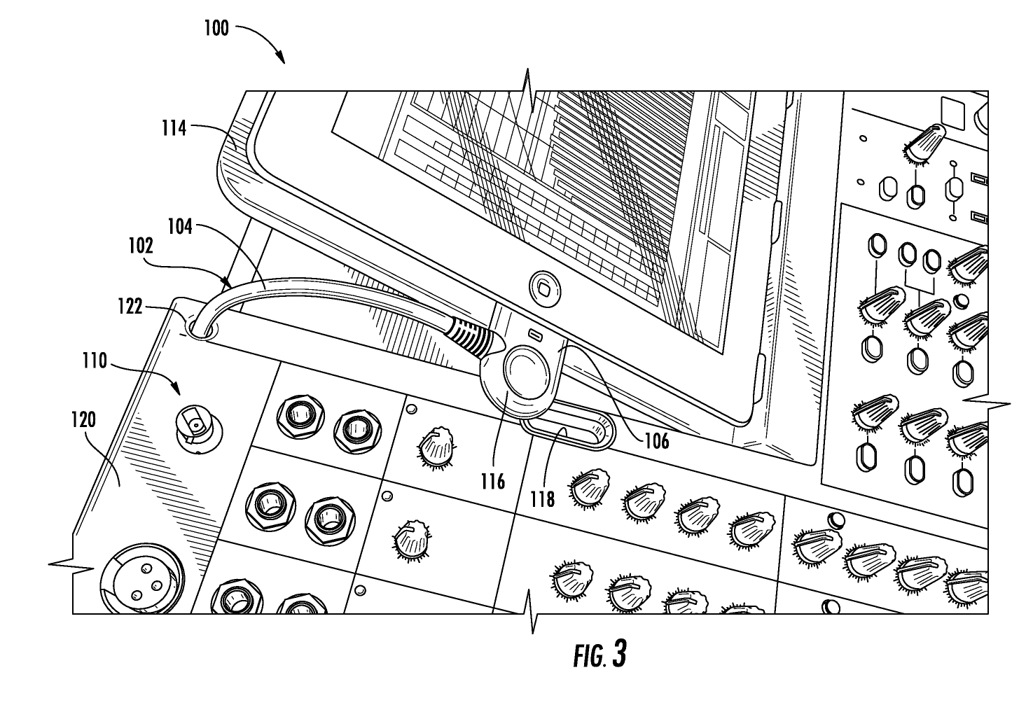

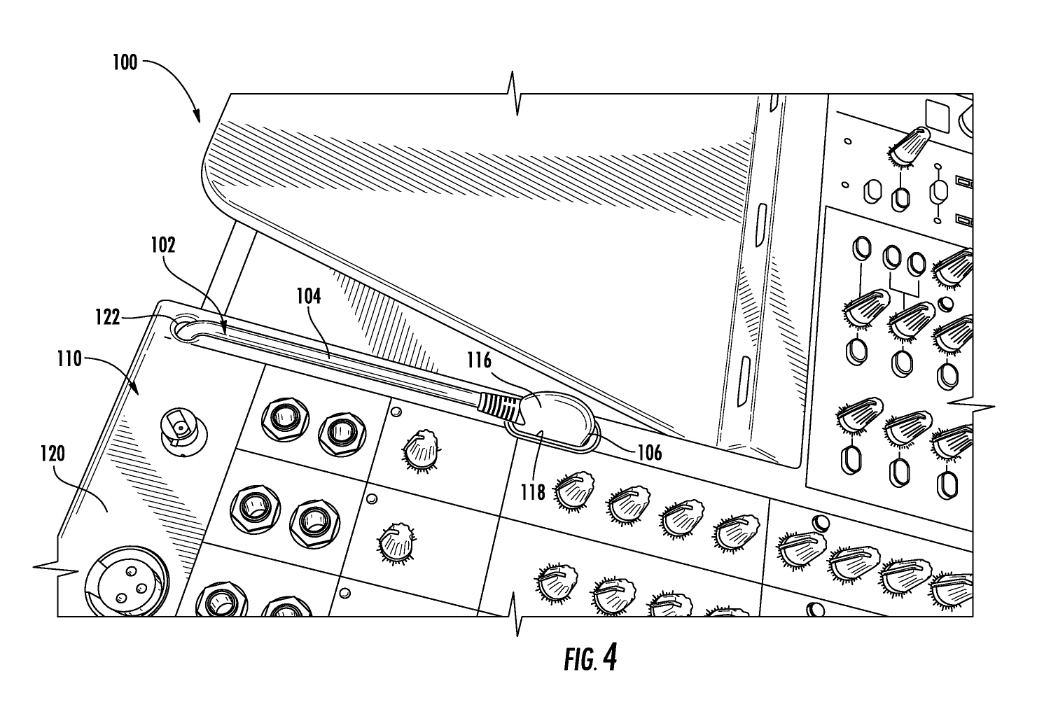

Referring to FIGS. 3 and 4, a second embodiment of an accessory device implementing the connector cable stowage system is shown generally at 100. The connector cable stowage system 100 includes a connector cable 102 having a cable 104 that terminates with a head 106. The cable 104 is connected to the electronics (not shown) contained inside a housing 108 of the accessory device 110.

The head 106 includes a connector 112 adapted to insert into a data port on a handheld computing device 114. Control signals from the accessory device 110 are transmitted through the connector cable 102 to the handheld computing device 114 as is known in the art. The head 106 further includes a grip portion 116, which permits the user to pry it from the head receptacle 118.

A head receptacle 118 molded in a housing 120 of the accessory device 110 a distance from the origin point 122 of the cable 104 of the housing 120. The head receptacle 118 is sized to receive the head 106 and connector of the connector cable 102 therein. Because the head receptacle 118 is nearly the same distance away from the origin point 102 as the cable 104 is long, the cable 104 is pulled taut when the head 106 of the connector cable 102 is placed in the head receptacle 118. In this manner, the cable 104 is kept from tangling.

The head receptacle 118 receives the head 106 of the connector cable 102 with a frictional fit, snap-fit or press-fit arrangement. The grip 116 of the head 106 protrudes from the head receptacle 118 when the head 106 is lodged in the head receptacle 118, which provides the user a point to grab in order to remove the head 106 form the head receptacle 118.

Therefore, it can be seen that the present invention provides a unique solution to the problem of providing a wired connection for an accessory device for a handheld computing device that permits the handheld computing device to be reoriented and also eliminates the limitation of having a dangling wire when not in use.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A connector cable stowage system for an accessory device for a handheld computing device, the accessory device having a housing, the stowage system, comprising:
a connector cable having a head with a connector and a cable, the connector adapted for electrical connection to a handheld computing device, the cable electrically connected to an accessory device; and
a head receptacle molded in the housing of the accessory device, the head receptacle configured and arranged to receive the head of the connector cable therein.

2. The connector cable stowage system of claim 1, further comprising a cable guide molded in a housing of the accessory device, the cable guide configured and arranged to receive the cable therein.

3. The connector cable stowage system of claim 2, wherein the cable guide is configured and arranged to receive the cable press-fit therein.

4. The connector cable stowage system of claim 1, wherein the head receptacle is configured and arranged to receive the head press-fit therein.

5. The connector cable stowage system of claim 1, wherein the head has a grip formed thereon.

6. The connector cable stowage system of claim 1, wherein the head receptacle includes a relief forming recess adjacent to the head when the head is placed in the head receptacle.

7. An accessory device for a handheld computing device, comprising:
a housing;
a connector cable having a head with a connector and a cable, the connector adapted for electrical connection to a handheld computing device, the cable electrically connected to an accessory device; and
a head receptacle molded in the housing of the accessory device, the head receptacle configured and arranged to receive the head of the connector cable therein.

8. The accessory device of claim 7, further comprising a cable guide molded in a housing of the accessory device, the cable guide configured and arranged to receive the cable therein.

9. The accessory device of claim 8, wherein the cable guide is configured and arranged to receive the cable press-fit therein.

10. The accessory device of claim 7, wherein the head receptacle is configured and arranged to receive the head press-fit therein.

11. The accessory device of claim 7, wherein the head has a grip formed thereon.

12. The accessory device of claim 7, wherein the head receptacle includes a relief forming recess adjacent to the head when the head is placed in the head receptacle.
